(19) United States
(12) Patent Application Publication
(10) Pub. No.: US 2025/0384689 A1
(43) Pub. Date: Dec. 18, 2025

(54) IMAGE SURVEILLANCE METHOD, IMAGE SURVEILLANCE SYSTEM, AND TERMINAL DEVICE

(71) Applicant: VIA Technologies, Inc., New Taipei City (TW)

(72) Inventors: Hsun-Yu Lin, New Taipei City (TW); Bo-Hsiang Hsu, New Taipei City (TW); Jinglin Liu, Shanghai (CN)

(73) Assignee: VIA Technologies, Inc., New Taipei City (TW)

(21) Appl. No.: 18/796,284

(22) Filed: Aug. 6, 2024

(30) Foreign Application Priority Data
Jun. 12, 2024 (TW) 113121599

(51) Int. Cl. G06V 20/52; G06T 5/50; G06V 20/70

(52) U.S. Cl. CPC G06V 20/52; G06T 5/50; G06V 20/70; G06T 2207/20221

(57) ABSTRACT

An image surveillance method, an image surveillance system, and a terminal device are disclosed. The image surveillance method includes the following steps: obtaining an original image through a camera module, and providing the original image to an artificial intelligence module and a server; analyzing the original image through the artificial intelligence module to generate an analysis result, and providing the analysis result to the server; providing the original image and the analysis result to the terminal device through the server; and displays the original image, the analysis result, or a superimposed image through the terminal device, where the superimposed image is a result of superimposed a part of the analysis result onto the original image.

### CROSS-REFERENCE TO RELATED APPLICATION

This application claims the priority benefit of Taiwan application serial no. 113121599, filed on Jun. 12, 2024. The entirety of the above-mentioned patent application is hereby incorporated by reference herein and made a part of this specification.

### BACKGROUND

### Technical Field

This disclosure relates to a display technology, and in particular to an image surveillance method, an image surveillance system, and a terminal device.

### Description of Related Art

Generally speaking, traditional image surveillance equipment used for image surveillance only analyzes the images and sends the analysis results back to the host computer, so it is quite inconvenient for some scenes that require the original images or remote secondary processing. In particular, for scenes that require remote secondary processing, if the back-end needs to count the analysis results of specific types of objects, traditional image surveillance equipment cannot mark the analysis results of all types of objects in the image that need to be judged beforehand, and thus cannot provide good image surveillance results.

### SUMMARY

The disclosure provides an image surveillance method, an image surveillance system, and a terminal device to achieve good image surveillance effects.

The image surveillance method of the disclosure includes the following. An original image is obtained through a camera module and the original image is provided to an artificial intelligence module and a server. The original image is analyzed through the artificial intelligence module to generate an analysis result, and the analysis result is provided to the server. The original image and the analysis result are provided to a terminal device through the server. The original image, the analysis result, or a superimposed image are displayed through the terminal device. The superimposed image is a result of superimposing a part of the analysis result onto the original image.

The image surveillance system of the disclosure includes a terminal device, a server, an artificial intelligence module, and a camera module. The server is coupled to the terminal device. The artificial intelligence module is coupled to the server. The camera module is coupled to the artificial intelligence module and the server. The camera module obtains the original image and provides the original image to the artificial intelligence module and the server. The artificial intelligence module analyzes the original image to generate an analysis result and provides the analysis result to the server. The server provides the original image and the analysis result to the terminal device. The terminal device displays the original image, the analysis result, or a superimposed image. The superimposed image is a result of superimposing a part of the analysis result onto the original image.

The terminal device of the disclosure includes a display unit, a communication interface, and a processing unit. The communication interface is coupled to the server and configured to receive an original image and an analysis result. The processing unit is coupled to the display unit and the communication interface, and is configured to display the original image, the analysis result, or a superimposed image through the display unit. The superimposed image is a result of superimposing a part of the analysis result onto the original image. The original image is provided through a camera module, and the analysis result is provided through an artificial intelligence module according to the original image.

Based on the above, the image surveillance method, the image surveillance system, and the terminal device of the disclosure may effectively display the original image, the analysis result, or the superimposed image. The superimposed image is a result of superimposing a part of the analysis result onto the original image.

To make the aforementioned more comprehensible, several embodiments accompanied

with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic diagram of an image surveillance system according to an embodiment of the disclosure.

FIG. 2 is a schematic diagram of a terminal device according to an embodiment of the disclosure.

FIG. 3 is a flow chart of an image surveillance method according to an embodiment of the disclosure.

FIG. 4 is a schematic diagram of an original image, an analysis result, and a superimposed image according to an embodiment of the disclosure.

FIG. 5 is a schematic diagram of data format of tag information according to an embodiment of the disclosure.

### DESCRIPTION OF THE EMBODIMENTS

In order to make the content of the disclosure easier to understand, the following

embodiments are provided as examples according to which the disclosure can be implemented. In addition, wherever possible, elements/components/steps with the same reference numerals used in the drawings and embodiments represent the same or similar parts.

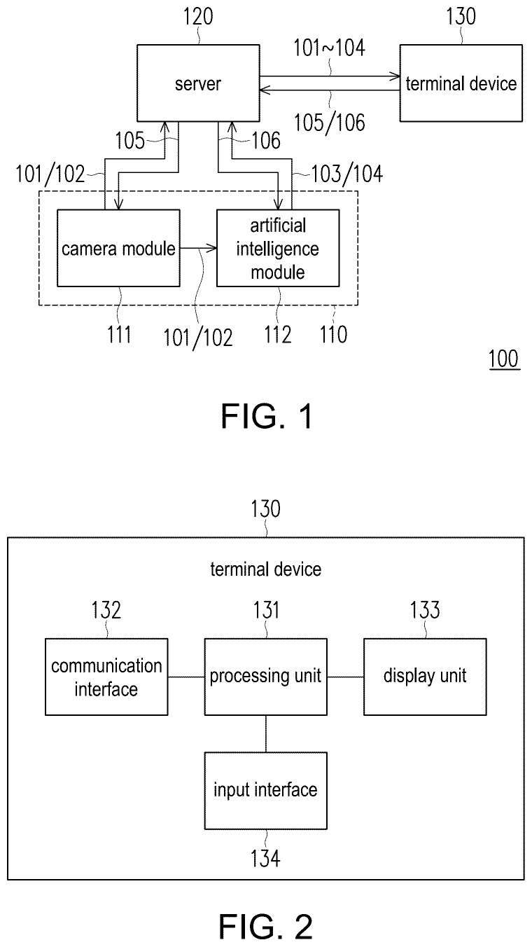

FIG. 1 is a schematic diagram of an image surveillance system according to an embodiment of the disclosure. Referring to FIG. 1, an image surveillance system 100 includes a camera module 111, an artificial intelligence (AI) module 112, a server 120, and a terminal device 130. In this embodiment, the camera module 111 and the artificial intelligence module 112 may be disposed in a same edge device 110, but the disclosure is not limited thereto. In an embodiment, the camera module 111 and the artificial intelligence module 112 may also be disposed in different devices. In this embodiment, the camera module 111 is coupled to the artificial intelligence module 112 and the server 120. The artificial intelligence module 112 is coupled to the server 120. The server 120 is coupled to the terminal device 130.

In this embodiment, the edge device 110 may be disposed in a remote image surveillance scene such as a manufacturing production line, a traffic intersection, or a specific surveillance environment, and may implement edge computing functions. The edge device 110 may also be equipped with a processor and a memory to analyze real-time image data generated by the camera module 111 through photography by executing the artificial intelligence module 112, and generate an analysis result. In this embodiment, the edge device 110 may be connected to the server 120 through wired or wireless communication, for example. The wired communication method may be cable, for example. The wireless communication may be implemented, for example, through Wi-Fi, Bluetooth, or other wireless communication interfaces. In this embodiment, the server 120 may be a cloud server or a web server, but the disclosure is not limited thereto. In an embodiment, the server 120 may also be a local device and is disposed in the same scene as the edge device 110.

In this embodiment, the terminal device 130 may be, for example, a smart phone, a personal computer (PC), a notebook computer, a tablet computer, or related electronic devices that have display functions and support a web browser. The terminal device 130 may be connected to the server 120 through wired or wireless communication to receive real-time surveillance image data and analysis results provided by the server 120 without delay. In this embodiment, the terminal device 130 may, for example, choose to display a real-time surveillance image, a real-time analysis result, or an image incorporating a portion of the analysis result on the real-time surveillance image according to a default display setting or a user setting.

The processor according to each embodiment of the disclosure may, for example, include a central processing unit (CPU), or other programmable general-purpose or special-purpose microprocessor, digital signal processor (DSP), image processing unit (IPU), graphics processing unit (GPU), programmable controller, application specific integrated circuits (ASIC), programmable logic device (PLD), other similar processing devices, or a combination of these devices. The memory according to each embodiment of the disclosure may include, for example, dynamic random access memory (DRAM), flash memory, or non-volatile random access memory (NVRAM).

FIG. 2 is a schematic diagram of a terminal device according to an embodiment of the disclosure. Referring to FIG. 1 and FIG. 2, in this embodiment, the terminal device 130 includes a processing unit 131, a communication interface 132, a display unit 133, and an input interface 134. The processing unit 131 is coupled to the communication interface 132, the display unit 133, and the input interface 134. In this embodiment, the terminal device 130 may receive the real-time surveillance image data and the analysis results provided by the server 120 through the communication interface 132, and display corresponding surveillance images through the display unit 133. In one embodiment, the terminal device 130 may also receive setting data for setting at least one of the camera module 111 and the artificial intelligence module 112 through the input interface 134, send the setting data to the server 120 through the communication interface 132, and then provide the setting data to the at least one of the camera module 111 and the artificial intelligence module 112 through the server 120.

In this embodiment, the processing unit 131 includes a processor and a memory. In this embodiment, the communication interface 132 may be a wired or wireless communication interface. In this embodiment, the display unit 133 may be a liquid crystal display (LCD), a light emitting diode (LED) display, an organic light emitting diode (OLED) display, or other type of display, and the disclosure is not limited thereto. In this embodiment, the input interface 134 may be, for example, an input device such as a touch panel, a mouse, or a keyboard that is integrated or not integrated with the display unit 133.

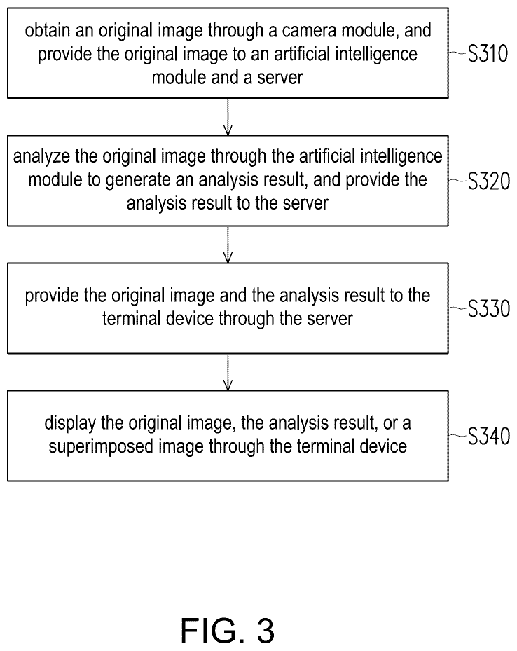

FIG. 3 is a flow chart of an image surveillance method according to an embodiment of the disclosure. Referring to FIG. 1 to FIG. 3, the image surveillance system 100 may perform the following steps S310 to S340. In step S310, the camera module 111 may obtain an original image 101 and provide the original image 101 to the artificial intelligence module 112 and the server 120. In step S320, the artificial intelligence module 112 may analyze the original image 101 to generate an analysis result 103, and provide the analysis result 103 to the server 120. In this embodiment, the artificial intelligence module 112 may, for example, include a classification model implemented through one or more neural network models (NN) trained to recognize a particular type of object in an image (e.g., an image of a person, an image of a face, or the appearance of an object) and to mark the particular object to produce an analysis result 103 with at least one tag information.

In step S330, the server 120 may provide the original image 101 and the analysis result 103 to the terminal device 130. In step S340, the terminal device 130 may display the original image 101, the analysis result 103, or a superimposed image. In this embodiment, the superimposed image may be a result of superimposing a part of the analysis result 103 onto the original image 101. In other words, the terminal device 130 may display an original surveillance image, an image of the analysis result, or a surveillance image superimposed with a part of the tag information. The tag information may include, for example, tag type, tag number, confidence value, and tag position information, but the disclosure is not limited thereto.

In this embodiment, the camera module 111 may number each frame of the original image 101 to simultaneously provide the original image 101 and an image number 102 corresponding to the each frame of the original image 101 to the artificial intelligence module 112 and the server 120. The artificial intelligence module 112 may identify specific types of objects in the each frame of the original image 101 to generate the analysis result 103 respectively corresponding to the each frame of the original image 101. The artificial intelligence module 112 may simultaneously provide the analysis result 103 and an image number 104 corresponding to the analysis result 103 of the each frame to the server 120.

In this embodiment, the server 120 may synchronize the original image 101 and the analysis result 103 according to the image number 102 corresponding to the original image 101 and the image number 104 corresponding to the analysis result 103. In this regard, since the process of analyzing the original image 101 by the artificial intelligence module 112 may cause delays, this embodiment transmits the original image 101 with real-time surveillance results and the analysis result 103 generated by the artificial intelligence module 112 separately, and matches the corresponding image numbers for frame synchronization processing at the server 120, so that the server 120 may provide the synchronized original image 101, the analysis result 103, the image number 102 corresponding to the original image 101, and the image number 104 corresponding to the analysis result 103 to the terminal device 130. In this way, the terminal device 130 may display the original image 101 or the analysis result 103 without delay, or the superimposed image (which may have a delay) according to user operation, display requirements, or default display. The superimposed image may be a result of superimposing a part of the tag information of the analysis result 103 onto the original image 101. Thus, the image surveillance system 100 and the terminal device 130 may achieve good image surveillance effects.

In this embodiment, the terminal device 130 may also return at least one of a camera module setting parameter 105 and an artificial intelligence module setting parameter 106 to the server 120. The server 120 may output the at least one of the camera module setting parameter 105 and the artificial intelligence module setting parameter 106 to at least one of the camera module 111 and the artificial intelligence module 112. In this embodiment, the camera module setting parameter 105 may include, for example, scene mode parameters, white balance parameters, focus, frame per second (FPS), or resolution, and other parameters, and the disclosure is not limited thereto. In this embodiment, the artificial intelligence module setting parameter 106 may include user instructions for controlling and setting the artificial intelligence module 112. The artificial intelligence module 112 may, for example, provide an adjustable parameter list (e.g., including weight parameter settings or accelerated operation parameter settings, etc.) to the terminal device 130, so that the user may perform settings through the input interface 134 of the terminal device 130, and generate corresponding setting parameters.

In one embodiment, the user may also annotate an object image in the analysis result 103 displayed by the display unit 133 through the input interface 134 of the terminal device 130. For example, the user may note the corresponding detailed object type for the objects judged in the analysis result 103. In other words, the artificial intelligence module setting parameters 106 may also include annotation information corresponding to tag results in the analysis result 103, and the artificial intelligence module 112 may be trained accordingly to automatically recognize the detailed object types of the corresponding objects in subsequent analysis.

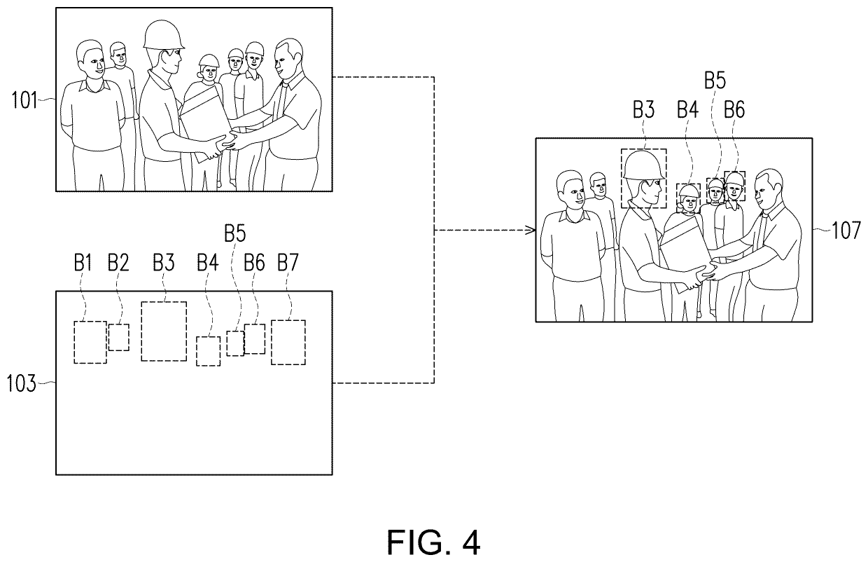

FIG. 4 is a schematic diagram of an original image, an analysis result, and a superimposed image according to an embodiment of the disclosure. Referring to FIG. 1 and FIG. 4, in the case of a scene with multiple person images, the original image 101 may be as shown in FIG. 4, and the original image 101 may, for example, include multiple person images, in which some people of the person images are not wearing helmets, and the other people of the person images are wearing helmets. The artificial intelligence module 112 may, for example, perform face recognition on the original image 101 to identify the faces of the person images, and generate an analysis result 103 with multiple tag information of multiple bounding boxes B1 to B7. Moreover, in addition to the bounding boxes B1 to B7, the tag information of the analysis result 103 may also have object judgment results (not shown) corresponding to each of the bounding boxes, such as object type, object size, or related object information (e.g., whether the helmet is worn).

In this embodiment, the terminal device 130 may select to display only the tag result of the image of people wearing the helmet according to the user settings or default display requirements. Thus, the terminal device 130 may display a superimposed image 107 as shown in FIG. 4, in which the superimposed image 107 may be a result of superimposing multiple tag information of the bounding boxes B3 to B6 on the original image 101. However, in other embodiments, the terminal device 130 may also directly display the original image 101 or the analysis result 103 according to user settings or default display requirements. In addition, the user may also annotate the tag information of the bounding boxes B1 to B7 through the terminal device 130, for example, to annotate a name of a person or a part of a person, and other detailed object types.

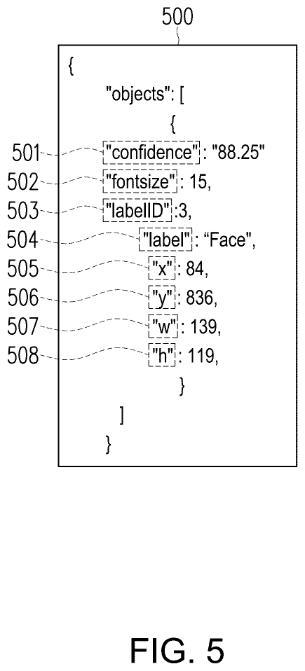

FIG. 5 is a schematic diagram of data format of tag information according to an embodiment of the disclosure. Referring to FIG. 1 and FIG. 5, the tag information described in various embodiments of the disclosure may, for example, have data format of tag data 500 as shown in FIG. 5. The tag data 500 may include a confidence value 501 (i.e., for example, confidence generated by the classification model of the artificial intelligence module 112), a font size 502, a tag number 503, and a tag type 504 (i.e., for example, a predicted object type result generated by the classification model of the artificial intelligence module 112), and tag position information. The tag position information may include, for example, an X-axis coordinate 505, a Y-axis coordinate 506, a box width 507, and a box height 508 of the bounding boxes (bounding boxes B1 to B7 as shown in FIG. 4) in the image, but the disclosure is not limited thereto. In one embodiment, when annotating the tag data 500 of the bounding boxes through the terminal device 130, the user may annotate the tag number 503 therein, such as annotating a name of a person or a part of a person corresponding to the tag number 503 of the bounding boxes, and the classification model of the artificial intelligence module 112 may generate the analysis result 103 that indicates the name of the person or part of the person according to the annotation of the tag number 503.

To sum up, the image surveillance method, the image surveillance system, and the terminal device of the disclosure may enable the terminal device to display the original image, the analysis result, or the superimposed image without delay to provide good image surveillance effects.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An image surveillance method, comprising:
obtaining an original image through a camera module and providing the original image to an artificial intelligence module and a server;
analyzing the original image through the artificial intelligence module to generate an analysis result, and providing the analysis result to the server;
providing the original image and the analysis result to a terminal device through the server; and
displaying the original image, the analysis result, or a superimposed image through the terminal device, wherein the superimposed image is a result of superimposing a part of the analysis result onto the original image.

2. The image surveillance method according to claim 1, wherein providing the original image to the artificial intelligence module and the server further comprises:
numbering a frame in the original image through the camera module to synchronously provide the original image and an image number corresponding to the frame in the original image to the artificial intelligence module and the server.

3. The image surveillance method according to claim 2, wherein providing the analysis result to the server comprises:
synchronously providing the analysis result and the image number corresponding to the analysis result to the server through the artificial intelligence module.

4. The image surveillance method according to claim 3, wherein providing the original image and the analysis result to the terminal device comprises:
synchronizing the original image and the analysis result according to the image number corresponding to the original image and the image number corresponding to the analysis result through the server; and
providing the original image, the image number corresponding to the original image, the analysis result, and the image number corresponding to the analysis result to the terminal device through the server.

5. The image surveillance method according to claim 1, wherein the analysis result comprises at least one tag information,
wherein the at least one tag information comprises a tag type, a tag number, a confidence value, and tag position information.

6. The image surveillance method according to claim 1, further comprising:
outputting at least one of a camera module setting parameter and an artificial intelligence module setting parameter to the server through the terminal device; and
outputting at least one of the camera module setting parameter and the artificial intelligence module setting parameter to at least one of the camera module and the artificial intelligence module through the server.

7. The image surveillance method according to claim 6, wherein the artificial intelligence module setting parameter comprises annotation information corresponding to a tag result in the analysis result.

8. The image surveillance method according to claim 1, wherein the camera module and the artificial intelligence module are disposed in an edge device.

9. An image surveillance system, comprising:
a terminal device;
a server, coupled to the terminal device;
an artificial intelligence module, coupled to the server; and
a camera module, coupled to the artificial intelligence module and the server,
wherein the camera module obtains an original image, and provides the original image to the artificial intelligence module and the server, and the artificial intelligence module analyzes the original image to generate an analysis result, and provides the analysis result to the server,
wherein the server provides the original image and the analysis result to the terminal device, and the terminal device displays the original image, the analysis result, or a superimposed image, wherein the superimposed image is a result of superimposing a part of the analysis result onto the original image.

10. The image surveillance system according to claim 9, wherein the camera module numbers a frame in the original image to synchronously provide the original image and an image number corresponding to the frame in the original image to the artificial intelligence module and the server.

11. The image surveillance system according to claim 10, wherein the artificial intelligence module simultaneously provides the analysis result and the image number corresponding to the analysis result to the server.

12. The image surveillance system according to claim 11, wherein the server synchronizes the original image and the analysis result according to the image number corresponding to the original image and the image number corresponding to the analysis result,
wherein the server provides the original image, the image number corresponding to the original image, the analysis result, and the image number corresponding to the analysis result to the terminal device.

13. The image surveillance system according to claim 9, wherein the analysis result comprises at least one tag information,
wherein the at least one tag information comprises a tag type, a tag number, a confidence value, and tag position information.

14. The image surveillance system according to claim 9, wherein the terminal device outputs at least one of a camera module setting parameter and an artificial intelligence module setting parameter to the server, and the server outputs at least one of the camera module setting parameter and the artificial intelligence module setting parameter to at least one of the camera module and the artificial intelligence module.

15. The image surveillance system according to claim 14, wherein the artificial intelligence module setting parameter comprises annotation information corresponding to a tag result in the analysis result.

16. The image surveillance system according to claim 9, wherein the camera module and the artificial intelligence module are disposed in an edge device.

17. A terminal device, comprising:
a display unit;
a communication interface, coupled to a server, configured to receive an original image and an analysis result; and
a processing unit, coupled to the display unit and the communication interface, configured to display the original image, the analysis result, or a superimposed image through the display unit, wherein the superimposed image is a result of superimposing a part of the analysis result onto the original image,
wherein the original image is provided through a camera module, and the analysis result is provided through an artificial intelligence module according to the original image.

18. The terminal device according to claim 17, wherein the analysis result comprises at least one tag information,
wherein the at least one tag information comprises a tag type, a tag number, a confidence value, and tag position information.

19. The terminal device according to claim 17, wherein the processing unit outputs at least one of a camera module setting parameter and an artificial intelligence module setting parameter to the server through the communication interface, and the server outputs at least one of the camera module setting parameter and the artificial intelligence module setting parameter to at least one of the camera module and the artificial intelligence module.

20. The terminal device according to claim 19 further comprising:
an input interface, coupled to the processing unit,
wherein the processing unit obtains annotation information corresponding to a tag result in the analysis result through the input interface, and the artificial intelligence module setting parameter comprises the annotation information corresponding to the tag result in the analysis result.
